(19) United States
(12) Patent Application Publication
(10) Pub. No.: US 2004/0197052 A1
(43) Pub. Date: Oct. 7, 2004

(54) Optical device

(75) Inventors: Shuhei Toyoda, Nagoya-City (JP); Masashi Fukuyama, Nagoya-City (JP); Yasunori Iwasaki, Nagoya-City (JP); Akiyoshi Ide, Nagoya-City (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 10/732,203

(22) Filed: Dec. 10, 2003

Related U.S. Application Data
(60) Provisional application No. 60/435,105, filed on Dec. 20, 2002.

(51) Int. Cl. G02B 6/30

(52) U.S. Cl. 385/49; 385/137

(57) ABSTRACT

The optical fiber array by which the optical device was fixed to V grooves of the glass substrate with which V grooves was formed, and this glass substrate, and reflective functions (a slit, optical tapping member, etc.) were provided in each optical fiber,

PD array which adhered to the optical on the street one of the reflect light generated by a reflective function at least among besides the clad of each optical fiber via adhesives,

It has sub-mount for mounting this PD array, and the mounting side of PD array makes this sub-mount counter said glass substrate, and it is installed.

### BACKGROUD OF THE INVENTION

1. Field of the Invention

The present invention relates to an optical device having one optical fiber or a plurality of optical fibers (optical fiber array). In particular, the present invention relates to an optical device which is preferably used when a signal light, which is transmitted through an optical fiber, is monitored at an intermediate position of the optical fiber.

2. Description of the Related Arts

Nowadays, a wavelength division multiplexing by a optical fiber amplifier has been developed. A quantity of light transmitted through an optical fiber is monitored at respective wavelengths in the wavelength division multiplexing. After a quantity of light monitored is adjusted, a quantity of light adjusted is amplified by the optical fiber amplifier to maintain an amplifier characteristics.

A variety of methods are known for the monitoring. However, monitor devices are mounted for respective fibers. Therefore, an optical device is larger in size.

For this reason, it is demanded to realize a small size and a-high density of the monitor device. Further, when the monitoring is performed, a part of the signal light is split from the optical fiber. However, it is demanded to monitor a signal light transmitted through the optical fiber without attenuation of the signal light.

A technique as shown, for example in Japanese Laid-Open Patent Publication No. 2001-264594 is proposed. In this technique, an optical fiber is disposed on a V-groove formed on a glass substrate, and then a parallel groove is formed in the glass substrate so that the parallel groove extends obliquely across the optical fiber (with respect to the optical axis of the optical fiber). And a member for reflecting light (optical member) is inserted into the parallel groove, and a gap of the parallel groove-is filled with an ultraviolet-curable resin (adhesive).

Accordingly, a signal light transmitted through the optical fiber is reflected by the member and a light component (reflected light) of the signal light is split outside a clad of the optical fiber. Therefore, when the reflected light is detected, for example, by a photodetector, it is possible to monitor the signal light.

By the way, usually, when the photodetector is mounted outside the one or more optical fibers, it is conceived that the photodetector, which is mounted on the wiring board, is mounted on the one or more optical fibers in consideration of the electric wiring. Even when the wiring board is simply mounted on the substrate in a state in which the photodetector is directed upwardly, the distance from the surface of the clad to the photodetector is lengthened. Specifically, the distance is a total of the distance between the one or more optical fibers and the wiring board, the thickness of the wiring board, and the distance from the wiring board to the light-receiving surface of the photodetector. Therefore, as described above, the loss of the reflected light and the crosstalk may be caused.

### SUMMARY OF THE INVENTION

The present invention is made in consideration of such a subject, an object of which is to provide an optical device in-which it becomes possible that the light-receiving surface of a photodetector is disposed closely to the clad surface of the one or more optical fibers, and it becomes possible to effectively improve the sensitivity in photodetecting and reduce the crosstalk.

According to the present invention, there is provided an optical device comprising first substrate where a V-groove is formed; one or more optical fibers in which it is fixed to said V-groove, and the reflective function is provided; an optical element fixed on at least the optical path of a reflected light generated by said reflective function among outside a clad of the optical fiber via adhesive; and second substrate for mounting said optical element, wherein said second substrate has the mounting surface of said optical element provided opposing said first substrate. Thereby, in case the second substrate is installed on the first substrate, said optical element can be turned and installed in an optical fiber, and it becomes possible that said optical element is disposed closely to the clad surface of the one or more optical fibers, and it becomes possible to effectively: improve the sensitivity in photodetecting and reduce the crosstalk.

And the electrode layer may be formed in at least the portion in which said optical element is mounted among main surface of said second substrate, and is formed the anisotropy electric conduction paste in the portion opposing the activity layer of said optical element.

Thereby, reflection and dispersion of the reflected light within the optical element are suppressed, and it becomes still more effective in reduction of crosstalk.

The purpose and other purposes, the above-mentioned feature, and an above-mentioned advantage will become clear from explanation of the following suitable example of an embodiment which cooperates with the attached drawing.

### BRIEF DESCRIPTION OF THE DRAWINGS

FIG. 1 is a sectional view showing the principal part of the optical device concerning this embodiment.

FIG. 2 is a perspective diagram seeing through and showing a part of optical device concerning this embodiment.

FIG. 3 is a process block diagram showing the production method of the optical device concerning this embodiment.

FIG. 4 is a perspective diagram showing a glass substrate.

FIG. 5 is a side view showing a glass substrate.

FIG. 6 is a perspective diagram showing the state where the in-line fiber array was assembled on the glass substrate.

FIG. 7 is a diagram showing how to carry out accommodation installation of the optical fiber array in V groove on the glass substrate.

FIG. 8 is a diagram showing other methods of carrying out accommodation installation of the optical fiber array in V groove on the glass substrate.

FIG. 9 is a perspective diagram showing the state where the slit was processed into the in-line fiber array.

FIG. 10 is a sectional view showing the state where the slit was processed into the in-line fiber array.

FIG. 11A is the diagram showing the state where the adhesives or fiber fixed resin for optical fiber fixation remained in the upper part of an optical fiber.

FIG. 11B is the diagram showing the state where said adhesives or resin in the upper part of an optical fiber was removed.

FIG. 12 is a diagram showing back incidence type PD array used in the optical device concerning this embodiment.

FIG. 13 is a sectional view showing the state where PD array was mounted in the undersurface of sub-mount.

FIG. 14 is a perspective diagram showing the state where mounted sub-mount in which PD array was mounted in the optical fiber array, and it was considered as the optical head.

FIG. 15A is the sectional view showing the state where the spacer was fixed to the undersurface of sub-mount.

FIG. 15B is the bottom plan view showing the state where the spacer was fixed to the undersurface of sub-mount.

FIG. 16 is a perspective diagram showing the state where die bonding of the optical head was carried out to the package.

FIG. 17 is a perspective diagram showing the state where wire bonding of the electrode pad of sub-mount and the pin of a package was carried out.

FIG. 18 is a perspective diagram in which fixing a ring and boots to an optical head and showing further the state where resin closure of the optical head was carried out.

FIG. 19 is a perspective diagram showing the state where the lid was fixed to the upper surface opening of a ring.

### DESCRIPTION OF THE PREFERRED EMBODIMENTS

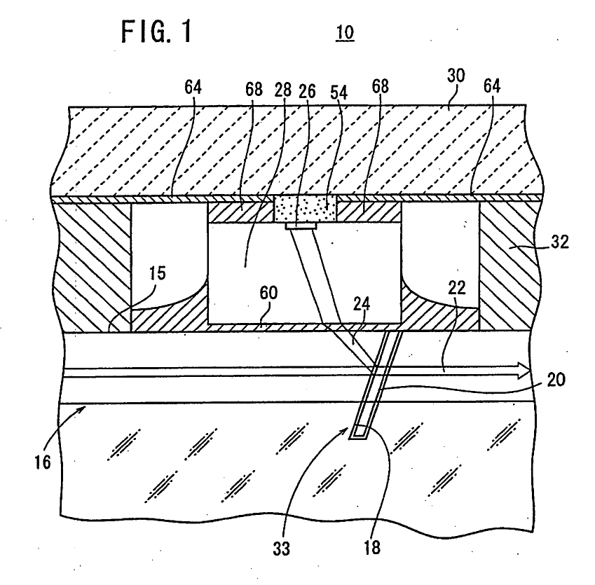

The embodiment which applied the optical device concerning this invention and its manufacture method to the 12 ch in-line type power monitor module hereafter is explained referring to FIG. 1-FIG. 19.

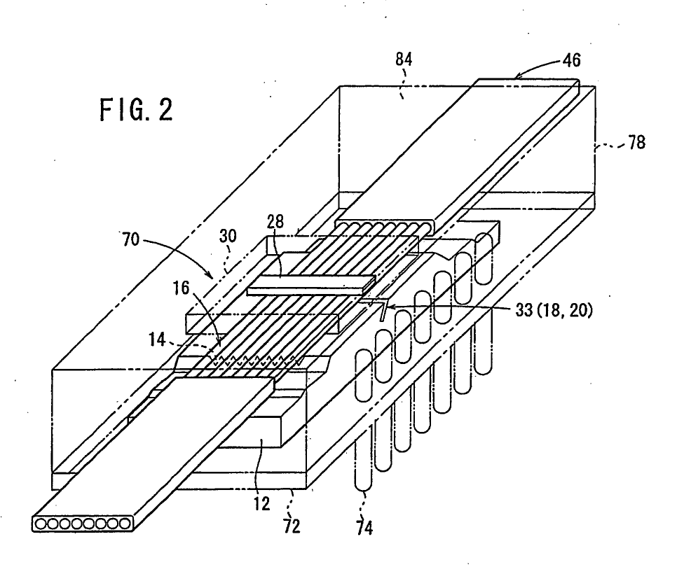

The optical device 10 concerning this embodiment comprises, as shown in FIG. 1 and 2, A glass substrate 12 and the optical fiber array 16 which comprises two or more optical fibers 15 fixed to two or more V groove(s) 14 established in this glass substrate 12,

the slit 18 is formed from each upper surface of the optical fiber 15 to the glass substrate 12,

the inside of the optical tapping member 20 inserted into this slit 18, and the light 22 which penetrates each optical fiber 15,

the PD (photo-diode) array 28 by which two or more active layers 26 which detect the light (reflect light) 24 reflected in the optical tapping member 20 etc. at least were arranged,

the sub-mount in which the PD array 28 is mounted and said sub-mount is fixed so that the PD array 28 is opposite to the optical fiber array 16, and the spacer 32 for fixing the PD array 28 stably at least.

Two end surfaces of a slit 18 and the front and back surfaces of the optical tapping member 20 will function as a reflective part 33 which reflects a part of light 22 which penetrates an optical fiber 15.

Namely, the optical device 10 concerning this embodiment is formed by, the optical fiber array 16 by which it was fixed to the V grooves 14 of the glass substrate 12 with which the V grooves 14 was formed, and this glass substrate 12, and the reflective function (a slit 18, optical tapping member 20 etc.) was provided in each optical fiber 15,

the PD array 28 which adhered to the optical on the street one of the reflect light generated by a reflective function at least among besides the clad of each optical fiber 15 via adhesives 60,

it has sub-mount 30 for mounting this PD array 28, and the mounting side of the PD array 28 makes this sub-mount 30 counter said glass substrate 12, and it is installed.

Therefore, in case sub-mount 30 is installed on a glass substrate 12, the PD array 28 can be turned and installed in the optical fiber array 16, it becomes possible to make the PD array 28 approach each clad side of the optical fiber array 16, and improvement in optical acceptance sensitivity and reduction of cross talk can be aimed at effectively.

It forms the electrode pattern 64 in the portion in which the PD array 28 is mounted at least among said mounting sides of sub-mount 30, and is trying to form the anisotropy electric conduction paste 54 in each activity layer 26 of the PD array 28, and the portion which counters in this embodiment, as shown in FIG. 1. Thereby, reflection within the PD array 28 of reflect light and dispersion are suppressed, and it becomes still more effective in reduction of cross talk.

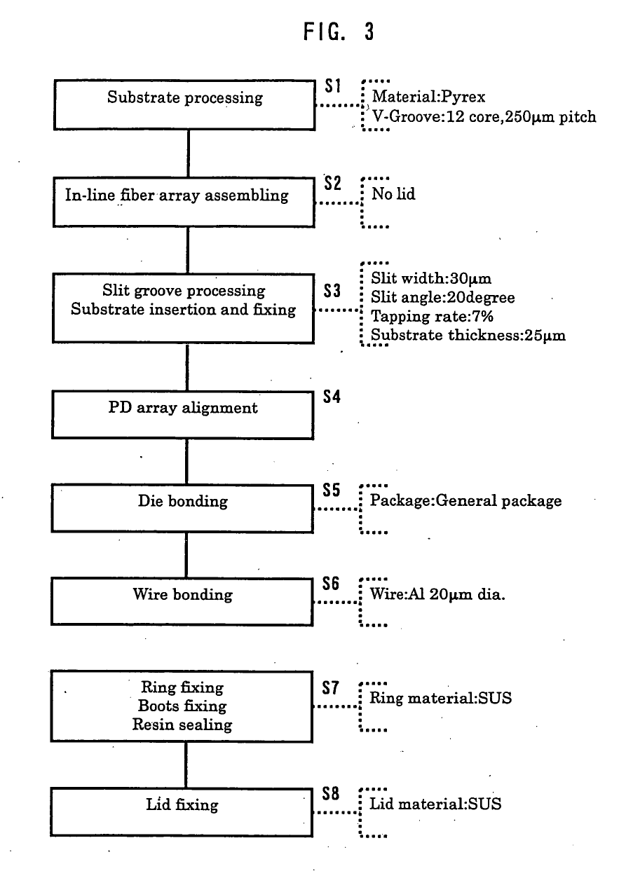

Next, it explains, referring to FIG. 3-FIG. 19 about the production method of the optical device 10 concerning this embodiment.

1) Substrate Processing Process

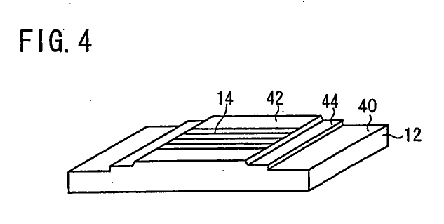

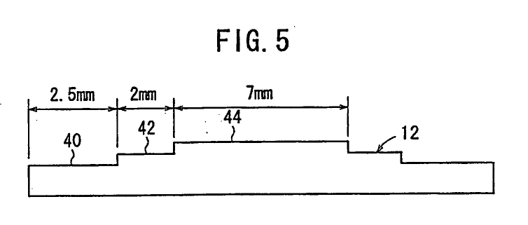

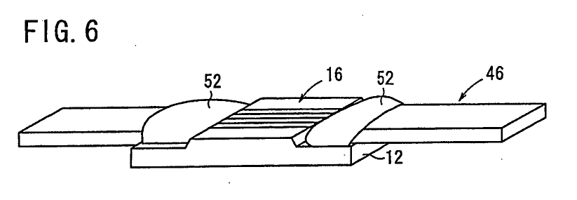

First, as shown in Step S1 of FIG. 3, and FIG. 4 and 5, the glass substrate 12 used for the in-line fiber array 16 (refer to FIG. 6) was created by grinding processing.

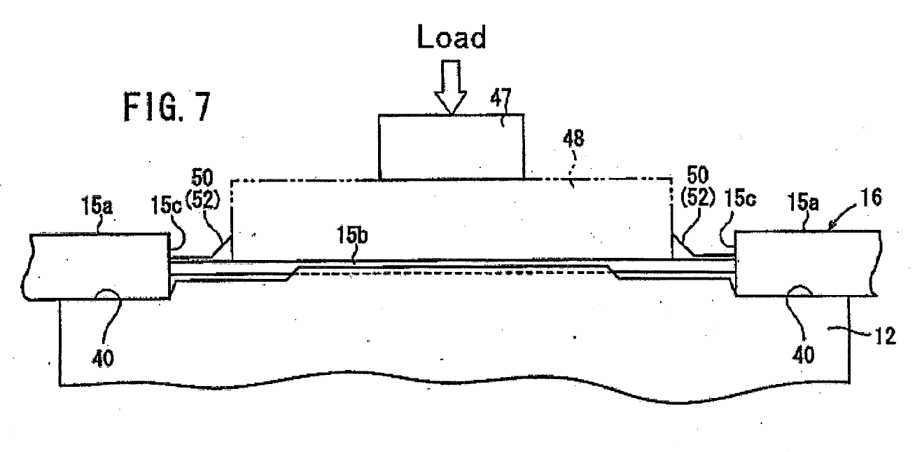

B2O3-SiO2 glass material (for example, Pyrex glass) was used for the material of a glass substrate 12. Making the chip size into 1 mm in a length of 16 mm, and thickness, the V grooves 14 for optical fiber alignment formed 12 V grooves 14 by grinding processing in 250-micrometer pitch and a depth of about 90 micrometers. The metal whetstone of #1500 was used for processing of the V grooves 14. The amount of [in which fiber clothing part 15a (refer to FIG. 7) of the optical fiber array 16 is laid among glass substrates 12/40 ] (fiber installation part) thin substrate portion set a depth of about 0.14 mm, and length to 2.5 mm from the end of a glass substrate 12 from the upper surface of a glass substrate 12. The fiber bending relief part 44 was formed between the portions (V grooves formation part) 42 and the fiber installation parts 40 in which the V grooves 14 was formed, and the length was set to 2 mm. The length of V grooves formation part 42 was set to about 7 mm.

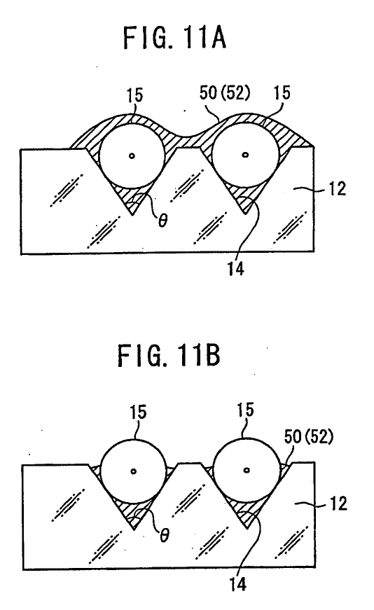

In addition, for example, as shown in FIG. 11A, if the load given to each optical fiber of the optical fiber array 16 was considered in case the angle theta of the V grooves 14 processes a slit 20 behind, in order that its 45 degrees or more might be preferred and might make it conversely a lid-less light fiber array, for reservation of sufficient amount of adhesives (=adhesion intensity), its 95 degrees or less were preferred, and made it 70 degrees by this embodiment.

2) Like an In-Line Fiber Array Assemble

Next, as shown in Step S2 of FIG. 3, and FIG. 6 and 7, the assembly of the in-line fiber array 16 was performed.

The optical fiber array 16 used 12-core tape cable 46 of 250-micrometer pitch. At intervals of 12 mm, an edge is put into covering by a common strip blade, and the crack is attached to two places so that an intermediate covering removal part (skinning inside part 16b) may be set to 12 mm. With the solvent (for example, methylene-chloride), between this crack was skinned inside, and was carried out, and it contained into V grooves 14 each of a glass substrate 12. By this removal method, covering removal edge 15c was able to be changed into the sharp state.

Next, accommodation installation of the optical fiber array 16 was carried out in the V grooves 14. Since it is in an in-line state, and the optical fiber is restrained on order both sides, there is little permission to position gap etc. Correctly, in order to carry out accommodation installation, the method was adopted as the V grooves 14 below.

First, as shown in FIG. 7, it fixes with the load Jig which does not illustrate, fiber covering part 15a of order, and changes into the state where the optical fiber stretched. A glass substrate 12 is arranged on the movable stage which is not illustrated the whole load jig, and this movable stage is adjusted and it arranges in the position whose V grooves 14 suits to an optical fiber 15 exactly. It is considered as the position which is the grade from which an optical fiber 15 is suppressed by the load of a stage in the V grooves 14, the temporary control board (dummy lid) 48 of Teflon with a length of 11.5 mm is arranged in the state, a load is applied from dummy lid 48 with the load jig 47, and an optical fiber is made to fix to the V grooves 14.

The ultraviolet curing type adhesives 50 are carried out from a dummy lid 48 order one side end to an application in this state. After resin has flowed out of another end, from the slanting upper part, ultraviolet rays are irradiated and carry out temporary fixation. It removes from the load jig 47 in the state of temporary fixation, and ultraviolet rays are again irradiated from the back of the optical fiber array 16. Dummy lid 48 was removed and ultraviolet rays were irradiated from the upper part (optical fiber side), and actual hardening of said adhesives 50 was carried out, it was considered as fiber fixed-resin 52, and the in-line fiber array 16 was completed.

Although mentioned later, since this resin 50 may have a bad influence on the characteristics in the PD array 28, such as PDL (polarization depending loss), if the fiber fixed resin 52 at this time remains in optical pass of reflect light 24, removing is preferred.

Although the following methods are-the modifications of an above-mentioned method, fiber fixed resin 52 can be prevented from remaining on reflect light way beforehand.

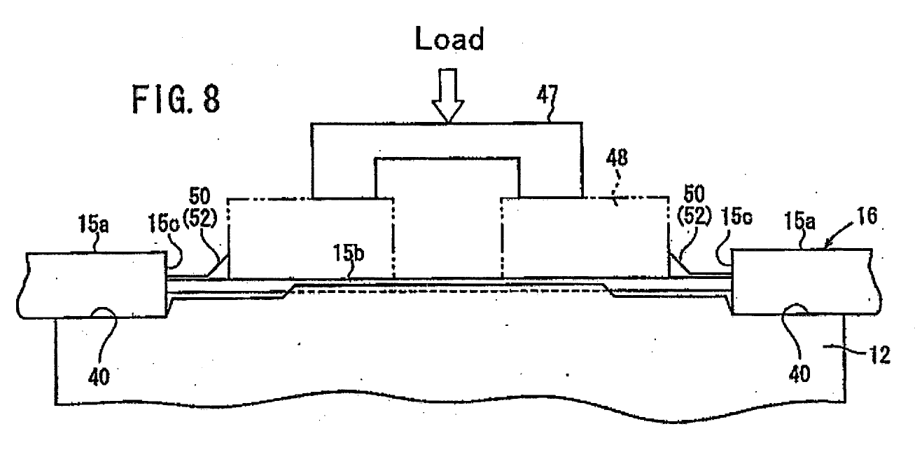

That is, as shown in FIG. 8, the temporary weight board 48 is made into the structure (the 1st and 2nd temporary weight board 48A and 48B) divided forward and backward, and it changes into the state where there is no fiber fixed resin 52 in optical pass of reflect light 24. In this case, adhesives 50 are applied from each end (side which approaches fiber covering part 16a, respectively) before and after the 1st and 2nd temporary weight boards 48A and 48B, and it will be in the state where fiber fixed resin 52 does not exist in optical pass of reflect light 24, completely by hardening adhesives 50 in the place where adhesives 50 flowed to near a center.

However, since the bottom (lower part of the = optical fiber 15) of V grooves 14 each is connected with the cross direction, respectively, said adhesives 50 flow in and it exists as fiber fixed resin 52. There is no fiber fixed resin 52 in optical pass of reflect light 24, and this state can be called suitable state of saying that necessary minimum fiber fixed resin 52 exists, at the time of processing of a slit 18. At the time of processing of a slit 18, it is because an optical fiber 15 will become the factor which gives fault to processing, such as producing a whetstone blocking and delicate whetstone vibration, if there is much resin 52 although adhesion fixation needs to be carried out.

3) Slit Processing, Optical Tapping Member Manufacture, a Optical Tapping Member Mounting Process

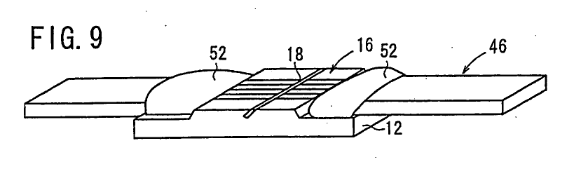

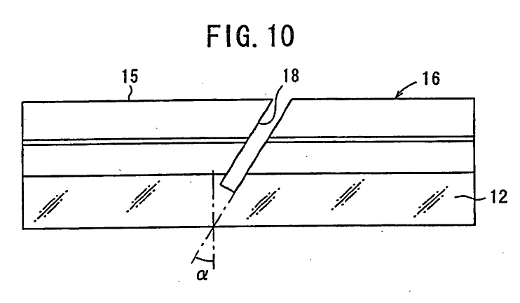

Next, the slit 18 was processed into the in-line fiber array 16 as shown in Step S3 of FIG. 3, and FIGS. 9 and 10. The slit 18 made the thickness of 30 micrometers, a depth of 200 micrometers, and the gradient angle a of 20 degrees.

As for the thickness of a slit 18, it is desirable that it is 5-50 micrometers. Since the member (optical tapping member 20) inserted in a slit 18 becomes thin too much in the case of less than 5 micrometers, mounting becomes difficult and is not preferred. When 50 micrometers or more, insertion loss becomes large and it stops being suitable for real specification.

As for the slit depth, it is desirable to be referred to as 130 micrometers-250 micrometers. Since it may become the form where in the case of less than 130 micrometers it stops as a processing slot is an optical fiber, a damage may be given to an optical fiber with this processing slot as the starting point. It is not desirable in order to cause the fall of the intensity of a glass substrate 12, if it is 250 micrometers or more.

As for an gradient angle a, it is desirable that it is 15 degrees-25 degrees. In the case of less than 15 degrees, it describes later, but there is a possibility of worsening the cross talk (interference) characteristic in the PD array 28, and when it is 25 degrees or more, there is a possibility that the polarization depending loss of the reflect light 24 in a tapping portion may get worse.

This slit 18 was formed by grinding processing in the resin bonded whetstone of #4000, the whetstone of 30 micrometers in thickness, and 75 mm phi. Whetstone number-of-rotations 12000 rpm and sending speed were made into 50 mm/min, using a micro grinder as a processing machine. At this time, a depth of 200 micrometers was performed by one processing (a cut depth of 200 micrometers). If the velocity of a whetstone is slow, a processing side will become close to a mirror surface, but the damage to a whetstone will be greatly connected with a crack etc. as a result, if velocity. is early, there are few whetstone damages, but a processing side becomes coarse a little. This balance determined the above-mentioned conditions.

Since the slit 18 was very thin and it became important [management of a whetstone] with 30 micrometers very much, before processing, the harder whetstone (GC#800) was processed first, pre-cutting was performed, next WA whetstone was processed and pre-cutting of a whetstone was performed. furthermore in this process, it needs pre-cutting process, it also needs accustomed process, after giving the precut to the dummy material of a processed thing and the Pyrex glass (50 mm) which is same material about 5 times finally and taming the whetstone.

Next, the optical tapping member 20 was manufactured. The substrate of the optical tapping member 20 was used as silica glass. When handling of the optical tapping member 20 etc. is taken into consideration, a plastic material, a polymer material, and polyimide material-are sufficient as the material of the optical tapping member 20, but since the angle is as large as 20 degrees, in order to suppress that optical axis by the side of a penetration shifts by refraction, the material of the same refractive index as an optical fiber. (quartz) is preferred.

The multilayer film for tapping was formed in this silica glass substrate. The quartz board was set to 50 mm □ x1t. The inclination design was considered as 20-degree reflection, and the rate of a branching ratio was considered as 93% of penetrations, and 7% of reflection. Film composition formed the multilayer film of SiO2, TiO2, and Al2O3 by the vapor-depositing method. The wavelength zone was designed so that the characteristic (reflectance) might become a flat in 1510 nm-1630 nm. The optimal design was carried out so that a <0.05 dB and reflection side might be set [penetration side] to <0.1 dB in the above-mentioned zone about a multilayer film's own polarization characteristic.

The quartz substrate which attached this multilayer film was cut and form chip in the 6 mm×2 mm size. The chip-formed substrate was ground to 25 micrometers, and thin substrate processing was performed. Using the #800 resin whetstone, it is processed with the side type grinding machine by 15 micrometer/min, and was made into 3 micrometer/min after the stage which became the thickness of 30 micrometers, and, finally spark out (not cutting deeply processing in this position) was given for 30 seconds. The relative number of rotations at this time was taken as 3500 rpm. Buff polish was given after completing polish by a side type grinding machine using coroidal silica with the Oscar grinder.

At this time, the reflective film by said multilayer film is formed in the polish side and the opposite side, and this field turns into a fixed side at the time of polish processing. For this reason, resist is beforehand applied to this field and it fixed with wax by the state where it protected. Although there was a meaning of protection, such as a crack, having removed completely was possible, without the wax which finally has the necessity for removal by this also remaining on a reflective film.

Finally the optical tapping member 20 was inserted in the slit 18, and it mounted by stiffening ultraviolet curing type adhesives by an application and ultraviolet-rays irradiation. After adhesives hardening, when the branch member 20 or adhesives has projected from the optical fiber upper part, it is desirable to fail to delete this. It is because it will become an obstacle at the time of mounting of the PD array 28 if this portion remains. Since this removal work is required, what has 50 or more-shoreD hardness as adhesives used here is preferred.

As shown in FIG. 11A, when the adhesives 50 or the fiber fixed resin 52 for fiber fixation remains, as shown in figure 11B, in the upper part of an optical fiber 15, it is desirable to also remove said adhesives 50 or resin 52. It is because-the polarization dependability of the light which carries out incidence to each activity layer 26 gets worse when such excessive adhesives 50 and resin 52 remain to optical pass to the PD array 28. If it has changed into the state-where said adhesives 50 or resin 52 cannot be found in the optical on the street one of reflect light, naturally removal work is also unnecessary.

4) PD Array Creation and Mounting to Sub-Mount

The number of channels of the PD array 28 was set to 12 ch, and the size was made into a height of 150 micrometers, a width of 420 micrometers, and a length of 3 mm.

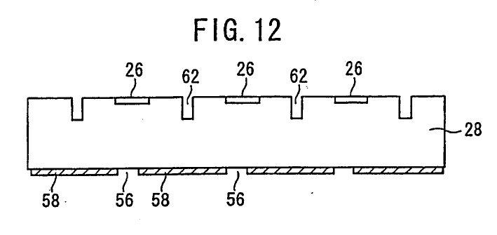

As shown in FIGS. 1 and 12, back surface incidence type structure was used for the structure of the PD array 28. As shown in FIG. 1, the upper part (sub-mount 30 side) of the activity layer 26 was taken as the anisotropy electric conduction paste 54 instead of Au solder, an electrode, or. silver paste. As for this portion, it is preferred like Au that it is in the state where reflectance is low, not like the quality of the material with high reflectance but like the anisotropy electric conduction paste 54 and air from a viewpoint of cross talk.

When surface incidence type PD array is used as a PD array 28, in order to take an electrical connection with Au solder, an electrode, etc. to the back side, reflection and dispersion of the light by which incidence was carried out take place by the back side to PD array board (InP), and it is easy to generate uselessness light. In order to reduce this, it is possible to prevent high reflection like Au by burying the electric conduction paste of the anisotropy in which omission and this portion have a refractive index between the refractive index of PD array board and the refractive index of air for the back part corresponding to the activity layer 26.

However, even if it suppressed reflection in the back as mentioned above, when the light which escaped from the circumference of the activity layer 26 is reflected and scattered about with the back in the case of surface incidence, it may arrive at the surface, re-combination (re-incidence) may be carried out to the activity layer 26 of other channels, and aggravation of cross talk will be caused under the influence of this uselessness light. On the other hand, in the case of back incidence, since the surrounding light of the surface activity layer 26 is reflected and scattered about immediately after and the part is absorbed by the activity layer 26 corresponding to an immediately near predetermined channel, satisfactory, the light which separated from it is again reflected and scattered about, after reaching to the back again, and only the absorption to the surrounding channel of the ingredient which came back to the surface poses a problem of cross talk this ingredient is markedly boiled as compared with the case of surface incidence, and it can be said that it is low.

And in this embodiment, as shown in FIG. 12, the metal mask structure which gave the metal film 58 which has two or more phi70 micrometer incidence windows 56 to the entrance plane side (surface) of the this back incidence type PD array 28 was adopted. As for the path of the incidence window 56, it is desirable that it is phi40-80 micrometer. Since cross talk poses a problem at the dimension of −30 dB, the incidence to the other channels of the very slight light also poses a problem. Since the PD array 28 will be reached after escaping from various states, such as the adhesives 60 (refer to FIG. 1) for fixing the clad and the PD array 28 of the core and the optical fiber 15 of the end surface and the optical fiber 15 of the adhesives and the slit 18 in a slit 18, if reflect light is seen when it stands on this viewpoint, it has been influenced of diffraction or dispersion. Slight reflection in two end surfaces of a slit 18 or the back of the optical tapping member 20 etc. is compounded by it, and reaches the PD array 28. When it considers to such few ingredients, incidence of the light which carries out incidence is carried out with a spread of about phi80-100 micrometer to the PD array 28. If incidence is carried out to the PD array 28, with this spread having, a part of light will cause uselessness light, in order to overflow the activity layer 26. Therefore, it becomes possible to raise the cross talk characteristic with restricting an opening to the PD array entrance plane side. In order to extract an opening too much about the size of the incidence window 56 in the case of less than 40 micrometers, PD optical acceptance efficiency (optical acceptance efficiency in the activity layer 26) will be reduced. If a window 80 micrometers or more is opened, the cross talk characteristic will get worse.

Since incidence of the reflect light 24 from the reflective part 33 is carried out to the PD array 28 with a certain angle, it cannot be overemphasized that the incidence window 56 is formed in the position in which reflect light 24 carries out incidence to the activity layer 26 the optimal.

The reflective portion (activity layer 26) of the back surface incidence type PD array 28 has about 60 micrometers in phi. As for the size of a reflective portion (activity layer 26), it is-desirable that it is phi40-80 micrometer. In the case of less than 40 micrometers, since a reflective portion (activity layer 26) has the too small size, we are anxious about decline in PD optical acceptance efficiency. It is because there is a possibility that in the case of 80 micrometers or more the cross talk characteristic may get worse since it becomes easy to gather uselessness light.

As shown in FIG. 12, each separation was performed for the block between the channels in the back surface incidence type PD array 28 by forming the physical grooves 62. Usually, for the block between such channels, how to form p type area between the channels of n type substrate, and form a barrier between channels can be considered. However, at this embodiment, the separation between channels was made more reliable by forming the physical grooves 62 of the depth more than the thickness with a depth of 2-20 micrometers of the activity layer 26 in the circumference of reflective area.

Composition called optical fiber 15-PD array 28-sub-mount 30 was taken as attachment composition of sub-mount 30. Although composition called the optical fiber 15-sub-mount 30-PD array 28 can also be taken, since sub-mount 30 exists between an optical fiber 15 and the PD array 28 in this case, the optical pass length of reflect light 24 becomes long, a spread of reflect light 24 becomes large, and it is not desirable in the viewpoint of PD optical acceptance efficiency or cross talk.

When the PD array 28 is changed into the state of surface incidence in the composition of optical fiber 15-PD array 28-sub-mount 30, wire bonding is needed for the electrical connection from the surface to sub-mount 30. In this case, about 100 micrometers of space are needed for wire bonding. This space needs to be covered with a meaning called refractive-index adjustment and reliability with an optical fiber 15 (quartz) with adhesives 60. That is, in the case of surface incidence, the no less than 100 micrometers adhesives 60 will exist in optical pass, and these adhesives 60 invite instability to the characteristics, such as PDL and wavelength dependence. In order that wire may usually use metal, such as Au, if light hits there, light will be scattered about, and it becomes uselessness light, and causes cross talk aggravation.

In the case of back incidence, it is also possible to touch an optical fiber 15 in the PD array 28 theoretically. Since there is a possibility of causing a physical defect, that an optical fiber 15 touches the PD array 28 sees about 10 micrometers of safety, and it should just use this space as adhesives 60.

These both optical pass length is compared. It will be set to 100/1.45≈69 micrometers if the refractive index of adhesives 60 sets to the 1.45 [same] as quartz, since the case of surface incidence is [the distance between the surface of an optical fiber 15 and the activity layer 26] 100 micrometers when it assumes that the activity layer 26 exists in the substrate surface (an optical fiber 15 and field which counters) of the PD array 28. If the thickness of 10 micrometers and the general PD array 28 sets [in the case of back incidence] to 150 micrometers in the thickness of adhesives 60, it is set to 10/1.45+150/3.5≈50 micrometers, the direction of back incidence can shorten optical pass length optically, and it can be said also from this viewpoint that it is desirable.

In the case of surface incidence and back incidence, the incidence angles of the light to the activity layer 26 differ greatly. In the case of surface incidence, if the angle of inclination angle a of a slit 18 is 20 degrees even when coating of silicon nitride (refractive index 1.94) is given for the surface, the incidence angle to the PD array 28 will become about 35 degrees. On the other hand, in the case of back incidence, as compared with 18.5 degrees and the case of surface incidence, it becomes a very small value, and it is preferred from viewpoints, such as PD optical acceptance efficiency.

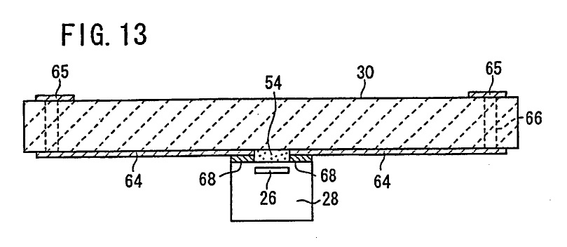

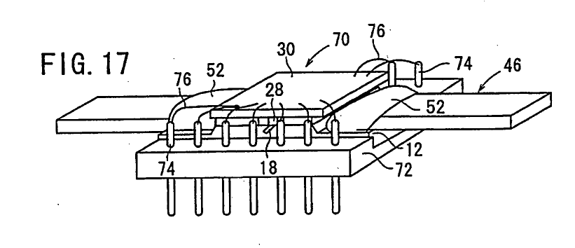

Next, mounting to sub-mount 30 of the PD array 28 was performed. The optical fiber array 16 side was carried in the package 72, and in order to consider the pin 74 of a package 72, and the electrode pad of sub-mount 30 as the composition which carries out electrical connection reservation by the wire bonding 76, as shown in FIG. 13, Au electrode pattern 64 was formed in the undersurface of sub-mount 30 so that it might mention later (refer to FIG. 17). The form of mounting of the PD array 28 has arranged the PD array 28 on the undersurface of sub-mount 30, and considered it as the composition which takes about the electrode pattern 64 to the upper surface of sub-mount 30 in the through hole 66. Therefore, it becomes the form where the electrode pad 65 was formed in the upper surface of sub-mount 30 according to each electrode pattern 64, respectively. Composition material of sub-mount 30 was set to aluminum 203.

The anode electrode and the cathode electrode are arranged at the activity layer 26 side (sub-mount 30 side), and, as for the back surface incidence type PD array 28, patterned of a common cathode electrode and the anode electrode of each channel is carried out by Au electrode pattern 64 at sub-mount 30. The Au vamp 68 was formed in the portion corresponding to the anode electrode and cathode electrode of each channel, and the portion of the activity layer 26 was filled up with the anisotropy electric paste 54. The Au vamp 68 is detaching the distance between electrodes of the activity layer 26 and sub-mount 30 other than the planning a positive electrical connection purpose, and she adopted this structure in order to make small uselessness light by reflection and dispersion of this portion. By applying heat, the anisotropy electric conduction paste 54 has the character in which electric conduction substances, such as silver in paste 54,, gather for a conductive thing like the Au vamp 68. This brings about conductivity only between Au electrode patterns 64. The electric conduction substance in the anisotropy electric conduction paste 54 remains under the incidence window 56 (refer to FIG. 12) produced by the PD array 28, and this scatters the light which came out from the window 54, and the role to prevent can also expect to return in the PD array 28.

Coating of, SiN was performed in order to suppress reflection by a refractive-index difference also into the portion corresponding to the activity layer 26 among the undersurfaces of sub-mount 30.

5) The Adjustment Process of PD Array (Optical Head Production)

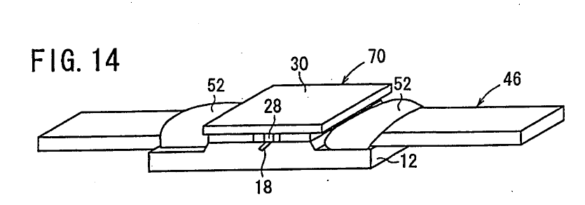

Next, as shown in Step S4 of FIG. 3, adjustment of the PD array 28 was performed, and as shown in FIG. 14, the optical head 70 was produced.

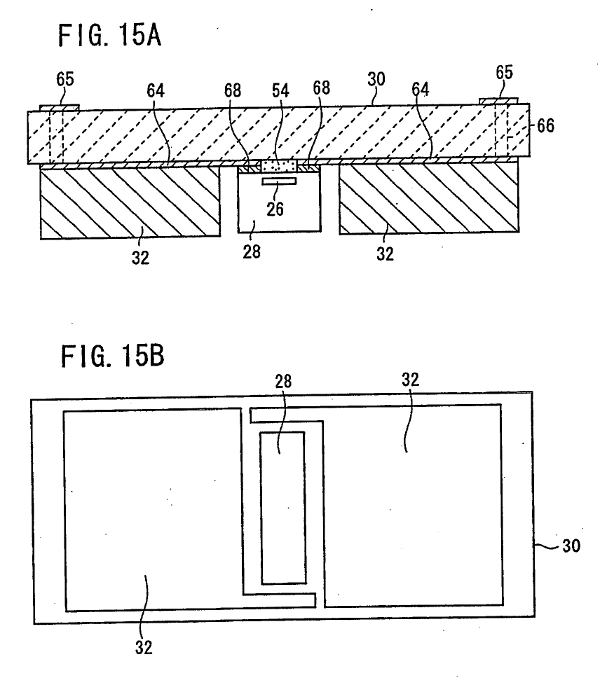

First, as shown in FIG. 15A, specifically, the spacer 32 for determining the gap of the optical fiber array 16 and the PD array 28 as sub-mount 30 was attached.

Especially composition material of a spacer 32 was made into Pyrex glass material in B2O3-SiO2 glass and this case. Gap length set it as 10 micrometers. That is, also including the Au vamp 68, since the thickness of PD array was 190 micrometers, the spacer 32 was set to 200 micrometers.

As for this gap length, it is preferred to design the thickness of a spacer 32 so that it may be set to 1-100 micrometers. In case of having under 1 micrometer gap length, the adhesives does not fill up, the air is involved in optical pass. If gap length exceeds 100 micrometers, decline in PD optical acceptance efficiency will be remarkable. In this way, the designed spacer 32 was fixed with ultraviolet curing type adhesives.

A spacer 32 plays the role of the plinth of sub-mount 30 in wire bonding besides determination of gap length. If wire bonding has a cavernous portion directly under the ,electrode portion of sub-mount 30 in order for an ultrasonic, wave to perform junction of an electrode and a wire, an ultrasonic wave will escape and it cannot carry out bonding appropriately. Therefore, as shown in FIG. 15B, the form of a spacer 32 is processed into the L character type so that a cave may not be made directly under an electrode.

Next, mounting to the optical fiber array 16 of sub-mount 30 was performed as mentioned above. At this time, as shown in FIG. 14, it mounted so that the PD array 28 and the optical fiber array 16 might counter.

First, a required quantity of the adhesives 60 (refer to FIG. 1) were applied to the upper part of the optical fiber 15 used as optical pass of reflect light 24. If adhesives 60 are not applied beforehand, since optical pass of reflect light 24 differ with air and adhesives 60, it is indispensable.

Next, the alignment with the PD array 28 carried out incidence of the light to the channel of the both ends of the optical fiber array 16, and it performed it in active alignment so that PD optical acceptance power (optical acceptance power in the activity layer 26 corresponding to a both-ends channel) of reflect light 24 might become the maximum. The monitor of PD optical acceptance power at this time applied the probe for the output from the activity layer 26 corresponding to a both-ends channel to sub-mount 30, and he carried out, looking at a current value.

At this time, in order to acquire the stricter characteristic, the operating wavelength at the time of adjustment was determined. That is, when the operating wavelength zone of this module was C band (1520-1570 nm), 1545 nm which is the center was used. 1590 nm is used when it was L band (1570-1610 nm). In the common case of C band and L band, 1565 nm which is the center of C band and L band was used. Thereby, the flat characteristic was able to be acquired to operating wavelength.

Finally, the PD array 28 was fixed to the optical fiber array 16 by ultraviolet rays. At this time, irradiation of ultraviolet rays was first performed on adjustment machine from the transverse direction by 100 mW for 10 minutes. In this stage, since it did not harden if it migrated to the whole inside although the adhesives 60 near the circumference of the PD array 28 were hardened next, it removed from adjustment machine, and from the back side of the optical fiber array 16, irradiation was performed in 10 mW for 5 minutes, and hardening fixation was carried out (secondary hardening). It was considered as 10 mW and feeble optical power by this secondary hardening in order not to make the adhesives 60 in the optical on the street one of reflect light 24 produce the defect of a big stress distortion, air bubbles, etc. In this stage, the optical head 70 shown in FIG. 14 is completed.

6) Package (PKG) die-bonding process

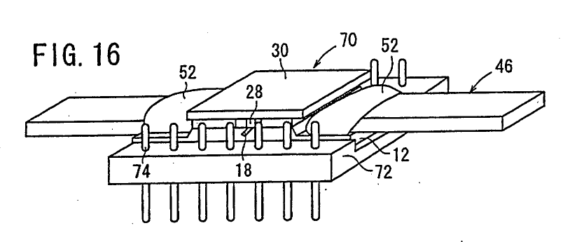

Next, as shown in Step S5 of FIG. 3, and FIG. 16, the so-called die bonding which adheres the optical head 70 to a part for the central part of a package 72 was performed.

The package 72 used the metal package of 14 pins. Outside was taken as a length of 20 mm and width of 12.5 mm. The optical head 70 was fixed to this package 72 with heat hardening type adhesives.

Since it would have a bad influence on the optical characteristic with these adhesives if a big distortion starts the optical fiber array 16, it was made fixation in a package 72 with the necessary minimum amount of adhesives. It was considered only as about 1 or about three area at the bottom of an optical fiber array (bottom of a glass substrate 12) as an adhesion area.

7) Wire Bonding Process

Next, as shown in Step S6 of FIG. 3, and FIG. 17, wire bonding was performed about between two or more pins 74 fixed to the both sides of a package 72, and the electrode pad 65 (refer to FIG. 14A) of sub-mount 30. The Al—Si wire of 76 phi20 micrometers of wires was used. Wire conditions used the pin 72 of a package 70 , and 2nd side as the electrode pad 65 of sub-mount 30 for the 1st side.

8) Resin Closure, a Lid Fixed Process

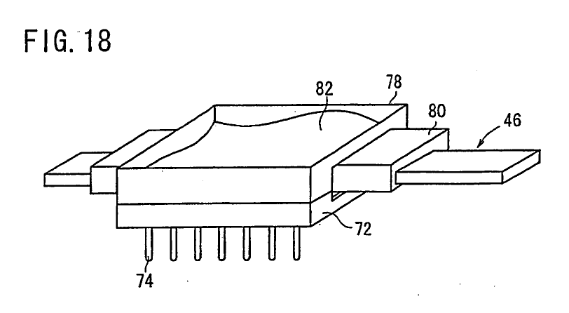

Next, as shown in Step S7 of FIG. 3, and FIG. 18, the ring 78 was fixed so that the optical head 70 might be surrounded, boots 80 were fixed to the derivation portion of the optical fiber array 16 in the optical head 70, and closure by resin 82 was further performed to the optical head 70.

A ring 78 plays the role of a dam in the case of resin closure. The composition material of a ring 78 used stainless steel material. A resin cast may be used from a viewpoint of cost reduction. The height of a ring 78 was set to about 4 mm. Heat hardening type adhesives were used for fixation of a ring 78. Boots 80 fixed the general-purpose boots made of rubber to the ring 78.

Si gel material was used for the resin 82 for closure. This was closed so that a wire 74 might be covered completely, and it was made to harden by ultraviolet-rays irradiation and heat care of health.

9) Lid Fixed Process

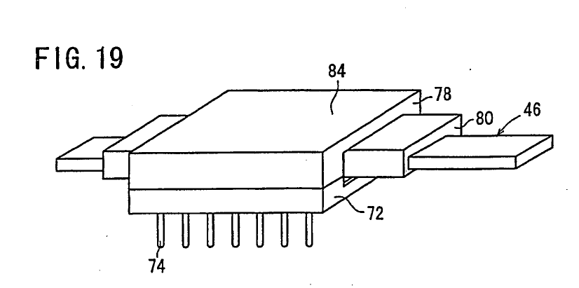

Next, as shown in Step S8 of FIG. 3, and FIG. 19, the lid 84 was put on the upper surface opening of a ring 78, and it fixed to it. The lid 84 used the board made from stainless steel. Of course, a resin cast may be used from a viewpoint of cost reduction. The lid 84 was fixed with heat hardening type adhesives, and it was considered as finished goods.

10) Complete Examination

The complete examination was carried out about the in-line type power monitor module (optical device 10 concerning this embodiment) completed through the above process.

Each item was inspected about the penetration side characteristic and the reflect side characteristic. The characteristic of each channel was measured about insertion loss, a polarization dependence loss, and wavelength dependability. As a result, the result of a satisfactory level was obtained on insertion loss <0.8 dB, polarization dependence loss <0.05 dB, wavelength dependability <0.1 dB, and use.

The characteristic of reflect light of each channel was measured about the cross talk between channels by the side of the polarization dependability of PD optical acceptance efficiency, wavelength dependability. Consequently, it is by polarization dependability <0.3 dB of PD optical acceptance efficiency of 50-70 mA/W, and wavelength dependability <0.5 dB, and checked that it was a satisfactory level on real use. About cross talk, it inspected as total cross talk. That is, total of the current of which where any one channel is shone, flowed to other channels is taken among 12 channels, and the ratio of total of the current in this input channel and the current of other channels is written by 10 log. Consequently, any channel was set to −34 dB or less, and it was checked that the extremely excellent characteristic is shown.

When cross talk improved when the angle alpha of a slit 18 (=the degree of angle of reflection) was enlarged, but PDL became large and made the angle alpha of a slit 18 small conversely, PDL suited the relation of trade-off that become small and cross talk gets worse, but in various rationalization, it was conventionally compatible in difficult PDL and cross talk.

As for the optical device concerning this invention, it is needless to say that various composition can be taken, without deviating not only from an above-mentioned embodiment but from the summary of this invention.

What is claimed is:

1. An Optical device comprising:
first substrate where a V-groove is formed;
one or more optical fibers in which it is fixed to said V-groove, and the reflective function is provided;
an optical element fixed on at least the optical path of a reflected light generated by said reflective function among outside a clad of the optical fiber via adhesive; and
second substrate for mounting said optical element,
wherein said second substrate has the mounting surface of said optical element provided opposing said first substrate.

2. An optical device according to claim 1, wherein the electrode, layer is formed in at least the portion in which said optical element is mounted among main surface of said second substrate, and is formed the anisotropy electric conduction paste in the portion opposing the activity layer of said optical element.
